(19) United States
(12) Patent Application Publication
(10) Pub. No.: US 2001/0034225 A1
(43) Pub. Date: Oct. 25, 2001

(54) One-touch method and system for providing email to a wireless communication device

(76) Inventors: Ash Gupte, Hillsboro, OR (US); Lisa Broman, Beaverton, OR (US)

Correspondence Address: PERKINS COIE LLP, PATENT-SEA, P.O. BOX 1247, SEATTLE, WA, 98111-1247, US

(21) Appl. No.: 09/782,686

(22) Filed: Feb. 12, 2001

Related U.S. Application Data
(60) Provisional application No. 60/181,953, filed on Feb. 11, 2000.

(51) Int. Cl. H04M 11/10

(52) U.S. Cl. 455/412; 455/466

(57) ABSTRACT

The present invention is directed systems and methods for providing selected electronic communications to a wireless communication device in response to only a single action by the user on the wireless communication device. One embodiment of the invention provides a system and method for notification and automatic delivery of a selected an audio email to a wireless communication device upon activation of only one key or other input member on the wireless communication device. Another embodiment provides a system and method of notification and delivery of a selected electronic communication upon activation of only one key or other input member on the wireless communication device so the user can immediately act on that electronic communication.

### CROSS REFERENCE TO RELATED APPLICATIONS

This application is a non-provisional patent application claiming priority to Provisional Patent Application No. 60/181,953 titled One-Touch Method for Providing Audio Email to a Cell Phone, filed Feb. 11, 2000, which is hereby incorporated by reference thereto.

### TECHNICAL FIELD

The present invention is directed to a message management system, and more particularly to a mobile message management system to deliver electronic communications to wireless communication devices.

### BACKGROUND OF THE INVENTION

A large number of communication systems have been developed and are used extensively by people to send and receive information. These systems include conventional landline telephone systems, wireless communication systems, voicemail systems, and electronic messaging (i.e., email) systems. These systems, particularly the wireless communication systems and email systems have allowed people to greatly increase mobility while still being able to access the communication systems to receive or send information.

The wireless communication devices, such as cell phones, allow a person to access voicemail systems and can also provide access to the Internet. The wireless communication devices can also allow the user to send or receive emails in text format. Laptops, notebook computers, as well as Personal Digital Assistants (PDAs) also allow a person to access the Internet, send text emails or receive text emails. Accordingly, business travelers can stay in touch with their offices and homes via email and voicemail through cell phones, computers, PDAs, and other wireless communication devices.

While the conventional communication systems can be extremely powerful tools, they still have some drawbacks and limitations. Laptops and notebook computers can be heavy and awkward to carry, and they can be cumbersome to use to access email, particularly when traveling. The wireless communication devices, such as cell phones and PDAs are easier to carry, and can send or receive emails in text format. Most wireless communication devices, however, have small display screens that limit the amount of information that can be seen. So, reading text messages can be cumbersome.

Some cell phones and other wireless communication devices that use a short message sending (SMS) protocol can only receive or send short messages with a limited number of characters (e.g, up to 160 or 250) per message. The wireless communication devices are also not typically configured to accept or handle attachment files on emails. The wireless communication devices are also configured so that a user must perform several actions or steps to access email to a point where the user can then act on a specific email. Accordingly, there is a need to provide easy and quick access to selected email or other electronic communications via a wireless communication device so the user can directly act on the selected communication.

### SUMMARY OF THE INVENTION

The present invention is directed systems and methods for providing selected electronic communications to a wireless communication device in response to only a single action by the user on the wireless communication device. One embodiment of the invention provides an email delivery system having an electronic data storage portion configured to receive and store emails so each email is stored in a unique location address. A message notification portion provides a unique notification to the wireless communication device that a selected email has been received. The notification contains a first data string that is unique to the selected email recognizable by the wireless communication device to allow the wireless communication device to initiate a response communication based upon the first data string upon activation of only one input member on the wireless communication device. A communication receiving portion is configured to receive the response communication from the wireless communication device, wherein the response communication includes the first data string and a second data string. The second data string includes identification information unique to the wireless communication device. An email-locating portion is configured to determine the unique location of the selected email on the electronic data storage portion based upon the combination of the first and second data strings. An email delivery portion is configured to deliver the selected email to the wireless communication device without requiring activation of a second input device on the wireless communication device.

An aspect of the invention also includes a method of providing selected email to a wireless communication device. In one embodiment of the method, emails are received by an electronic data storage device, and each email is stored on the electronic data storage device at a unique location. A message notification is sent to a wireless communication device indicating that a selected email was received by the electronic data storage device. The message notification in a protocol recognized by the wireless communication device and that allows the wireless communication device to connect to the electronic data storage device by activating only one activation member on the wireless communication device. The first data string is also unique to the selected email. A communication contact is received from the wireless communication device, wherein the communication contact includes the first data string and a second data string. The second data string includes data unique to the wireless communication device. The location of the selected email on the email electronic storage device is determined based upon the first and second data strings. The email is then transmitted to the wireless communication device so the user can listen to or otherwise directly act on the email.

### BRIEF DESCRIPTION OF THE DRAWINGS

FIG. 1 is a schematic representation of a mobile message management system in accordance with an embodiment of the present invention.

FIG. 2 is a schematic representation of a closed SMS data communication loop in the system of FIG. 1.

FIG. 3 is a schematic representation of a closed WAP data communication loop in the system of FIG. 1.

FIG. 4 is a schematic block diagram representing one communication flow in an embodiment of the system in FIG. 1.

FIG. 5 is a schematic flow diagram representing another communication flow in an embodiment of the system in FIG. 1.

### DETAILED DESCRIPTION

A mobile message management system and related methods in accordance with embodiments of the present invention are described in detail herein. The system and methods are configured to deliver a selected electronic communication message to a wireless communication device upon the user performing only a single action (e.g., depressing the “send” key on a cell phone). The following description provides specific details for a thorough understanding of, and enabling description for, embodiments of the invention. However, one skilled in the art will understand after reading the following description that the invention may be practiced without some these details. In other instances, well-known structures and functions have not been shown or described in detail to avoid unnecessarily obscuring the description of the embodiments of the invention.

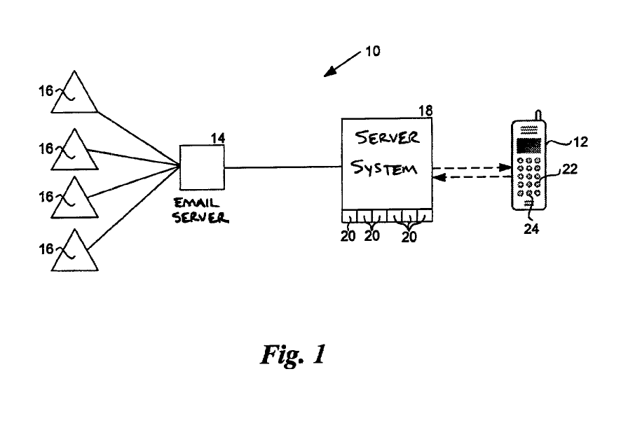

FIG. 1 is a schematic representation of the mobile message management system 10 of one embodiment of the present invention. The system 10 allows a user to directly access a selected message and act on that message (e.g., to listen to the message) via a cell phone 12 or other selected wireless communication device. This embodiment will be described with reference to email communications, although it is to be understood that the system and methods are applicable to other electronic communication messages, not just emails.

The message management system 10 is operatively connected to a user's email server 14, which is configured to receive a plurality of emails 16 sent to the user via his or her unique email address. The emails 16 may include text and attachments, such as a data file or an audio file (i.e., .wav file). The user's email server 14 sends that email to a second email server on a server system 18. This second email server can be configured with selected criteria rules to determine if an email 16 satisfies the selected criteria rules for handling the email. The server system 18 in one embodiment includes multiple servers 20 that perform a variety of actions, discussed in greater detail below. In another embodiment, the server system 18 may be only one server 20.

The server system 18 is configured, so that, if that an email is received that meets the selected criteria, the server system sends a notice the user's cell phone 12 indicating that a specific email has been received from the user's email server 14. The notice from the server system 18 has a selected protocol scheme, such as Short Message Service (SMS) scheme or Wireless Access Protocol (WAP) scheme, that is recognized by the cell phone 12. At least a portion of the protocol scheme in the notice has information that allows the cell phone 12 to automatically access the server system 18 with only a single action by the user, such as by pressing one key 22 on the phone's keypad 24. This single action by the user will provide the user with access to that one specific email message, so the user can receive or act on that message. Accordingly, the user can easily and quickly act on the one selected email without having to sort through a large number of other emails.

When the notification is provided in the SMS scheme in one embodiment, the notification includes an embedded phone number to the server system 18 that the cell phone 12 can dial to directly access the server system. The phone number is identified by the server system with a single email for that user's account. When the notification is provided in the WAP scheme in another embodiment, the notice includes an embedded URL linked to the server system 18 that the cell phone can directly access. The phone number or URL is identified or correlated by the server system with a single email account.

When the cell phone 12 responds to the server system 18, the server system identifies a selected portion of a protocol scheme, such as the phone number or the LJRL. The server system 18 also identifies a second data string that contains identification information about the cell phone 12 from which the user is accessing the server system. In this embodiment, the server system 18 includes a database with information about service subscribers and users, such as cell phone identification information, so the server system can correlate the identification information with a particular user's account. Based upon the combination of the first data string such as the phone number or URL for the selected email, and the second data string, such as the cell phone ID information or the URL, the server system 18 retrieves that user's specific email for which that notification was sent out. The user can then act on that email.

In one embodiment, server system 18 automatically converts the retrieved email from text to an audio email. The server system 18 then automatically plays that audio email for which the notice was delivered to the user via the cell phone 12. If the email message has attachment documents, the attachment documents can also be converted into one or more audio files and played to the user. The user can then act on that audio email after hearing it. Accordingly, the user only has to press one key 24 on the cell phone 12 to access and hear the selected email.

In another embodiment that provides the notification in a WAP scheme, the notification to the cell phone 12 initiates a WAP session for that specific email for which the notification was sent. During this WAP session, the cell phone 12 is automatically provided with number actions options in a menu format that can be performed for that email, such as listening, replying, forwarding, faxing, deleting or saving the email. The user can then act on the selected email via the desired menu selection. Accordingly, the user can immediately and directly access one specific email by pressing only one key 24 on the cell phone 12 so as to be able to immediately act on that email.

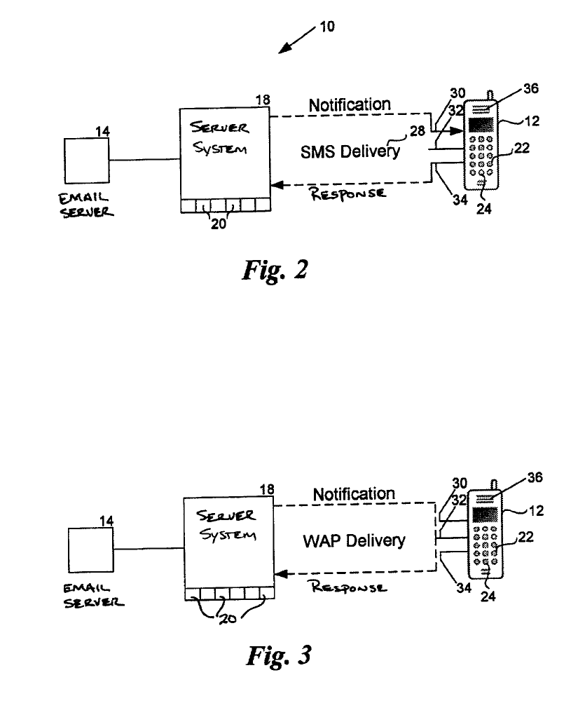

FIGS. 2 and 3 are schematic representations of closed data communication loops 28 between the server system 18 and the cell phone 12 for email management through the server system. The cell phone 12 of the illustrated embodiment has three channels along which different types of information or data can be transmitted. The first channel is a voice channel 30, the second channel is an SMS channel 32, and the third channel is a data channel 34. These three channels 30, 32, or 34 are used to provide the closed data communication loop 28 for transfer of information or data between the server system 18 and the cell phone 12. In one embodiment that provides for “one-touch audio email delivery” (FIG. 2), the server system 18 sends the notification of email arrival to the cell phone 12 in an SMS scheme along the SMS channel 30. The cell phone 12 receives the SMS scheme that includes a telephone number to the server system 18, wherein the telephone number is assigned by the server system to correspond to the specific email for which the notification was sent. The cell phone 12 is configured in a conventional manner to automatically dial the phone number in the SMS scheme, as an example, when the phone number is displayed on the cell phone's display screen 36 and the user pressing phone's the “send” key.

When the cell phone 12 dials the phone number to the server system 18, the phone call is made on the voice channel 34, thereby closing the communications loop 28 with the server system and providing a response from the cell phone. The server system 18 can then retrieve the specific email for which the notice was sent based upon the first and second data strings in the notification and response. The server system 18 then converts and automatically plays the email in an audio format over the cell phone's voice channel 30. This provides for extremely fast and efficient delivery of a specific audio email to the user with only a single touch of the cell phone 12.

As best seen in FIG. 3, another embodiment provides the notification from the server system 18 to the cell phone 12 along the data channel 32. The notification is provided in a WAP scheme that includes the URL specific to the email for which notification was sent. In this embodiment, the cell phone 12 includes a WAP browser that recognizes URLs. The cell phone 12 is configured so the user can depress a single key 24 on the key pad 22 (e.g., such as the “send” key), and the cell phone 12 will recognize and access the specific URL along the data channel 32, thereby closing the data communication loop 28. Accordingly, when the server system 18 sends the email receipt notification with the WAP scheme along the data channel 34, a WAP session is initiated from the server system 18. That WAP session is continued when the user responds to the notification and accesses the specific email for which the notice was sent. The user can then act on that specific email via the menu commands provided from the server system 18 to the cell phone 12.

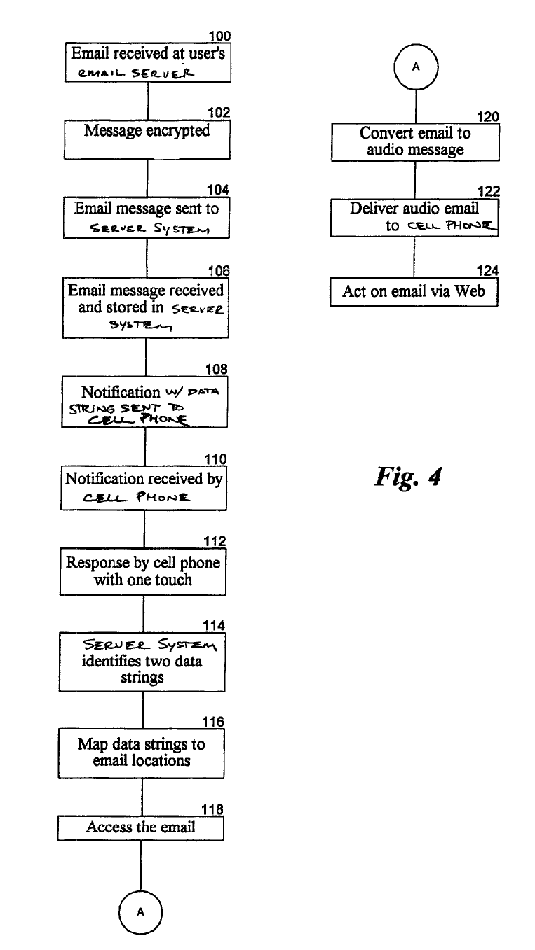

FIG. 4 is a schematic flow diagram showing a communication flow in an embodiment that uses an SMS scheme and provides automatic audio email delivery to the cell phone 12. In this embodiment, an electronic communication, such as an email, is received at a user's email server (block 100). The email can then be encrypted (block 102). In the illustrated embodiment, the email is encrypted with SSL encryption, although other encryption methods or techniques can be used. In other embodiments, separate encryption of the email may not be desired or necessary such that the encryption process is skipped. The email is sent to the server system (block 104). The email is also analyzed to determine if the email satisfies selected criteria to warrant forwarding the email for delivery to the user's cell phone. The email is received and stored in an electronic data storage portion of the server system, such as on an email server (block 106). The email is stored at a unique location specific for that email. When multiple subscribers to the server system are receiving multiple emails on the server system's data storage portion, each of the emails must be safely stored in a separate and unique location so as to be accurately retrievable and deliverable to the correct user.

In the present invention, when an email is received and stored (block 106), the server system evaluates the email for specific information usable for prioritizing and/or delivering the email. In one embodiment, the email's header, body, footer and any attachments are evaluated, such that information in any one of these sections can be utilized in a desired selection process to determine how or what part of an email is to be delivered to the user and in what order.

If the email satisfies the pre-selected criteria, a message notification portion of the server system sends a notification to the cell phone or other wireless communication device indicating receipt of the email (block 108). The notification in the illustrated embodiment contains a selected SMS scheme, and at least a part of the SMS scheme includes one specific phone number that the server system assigned to the specific email for which the notification was sent. The SMS scheme can also includes part of the email, such as the addressee information, date, and subject of the email. Other configurations of the SMS scheme can be utilized to provide information that is deemed important. In accordance with current technology, the SMS scheme can only utilize up to 160 or 250 characters, so the notification can only provide a limited amount of information to the user about the particular email.

As indicated above, each email notification contains one phone number specifically assigned to that email message for that user. If the user has, as an example, three emails stored at the server system that meet the selected criteria, then three separate notifications will be sent to the user. Each notification will be embedded with a separate phone number or other data string usable by the cell phone for the specific email for which that notice was sent. Conventional cell phones are configured to store up to only ten incoming messages or phone numbers before the phone's storage device is full. As a result, the server system only needs ten phone numbers to be available, so each phone number can correspond to a specific message for which the notification is being sent for that particular cell phone. After the user listening to or otherwise acts on the email, the phone number in the notification for that email can be disassociated with a particular email, and that phone number can be used again and assigned to another email. If cell phones are developed and can store an increased number of messages, then the corresponding number of phone lines that would be needed by the server system.

The notification is received by the cell phone (block 110) to let the user know that an email has been received. While the embedded phone number in the notification is displayed on the cell phone's screen, the user responds to the notification (block 112) by pressing the “send” button or other single action to dial that phone number and access the server system. A communication-receiving portion of the server system receives the phone call and identifies two separate data strings from the cell phone (block 114). In the illustrated embodiment, the first data string is the embedded phone number assigned to the email for which the notice was sent. The first data string can be in the form of Automated Number Identification (ANI) or the Dialed Number Identification String (DNIS). In other embodiments, other portions or all of a data string unique to the call from the cell phone can be identified.

The second data string identified by the server system is the cell phone identification information, such as caller ID or other unique cell phone identification data provided from a cell phone during a phone call. A message locating portion of the server system takes the two data strings and maps them to the specific storage location of that email for which the notification was sent to the cell phone (block 116). A server then retrieves the specific email (block 118). In the embodiment of FIG. 4, a conversion portion of the server system automatically converts the email from text to an audio message (block 120). In one embodiment, the conversion is performed by a text-to-speech program residing on one of the servers in the server system. It is to be noted that the communication steps up to this point have only required that the user push or activate a single key on the cell phone.

After the email is converted (block 120), the audio email is automatically delivered to the cell phone over the voice channel (block 122). Accordingly, with only one touch of a button, the specific email is retrieved, delivered and played so the user automatically hears the email in an audio format. After the audio email is delivered, the user can act on the email (block 124) in any one of a selected ways depending on the configuration of the server system. As an example, the user can respond to the email via voice, wherein the user's voice response is converted into a .wav file and attached to a reply email that is sent to the emails original sender. Alternatively, the user can forward the email, store the email, delete the email, save the email, fax the email to a selected recipient, or any other selected action provided by the server system. After the user acts on the particular email, the user can end the cell phone call. If another email that meets the selected criteria has been received by the server system and a separate notification has been delivered to the user's cell phone, the user can respond to that notification. Accordingly, with only one touch, the cell phone will dial the separate telephone number embedded in the SMS scheme for that new email, and the audio email is automatically delivered to the user.

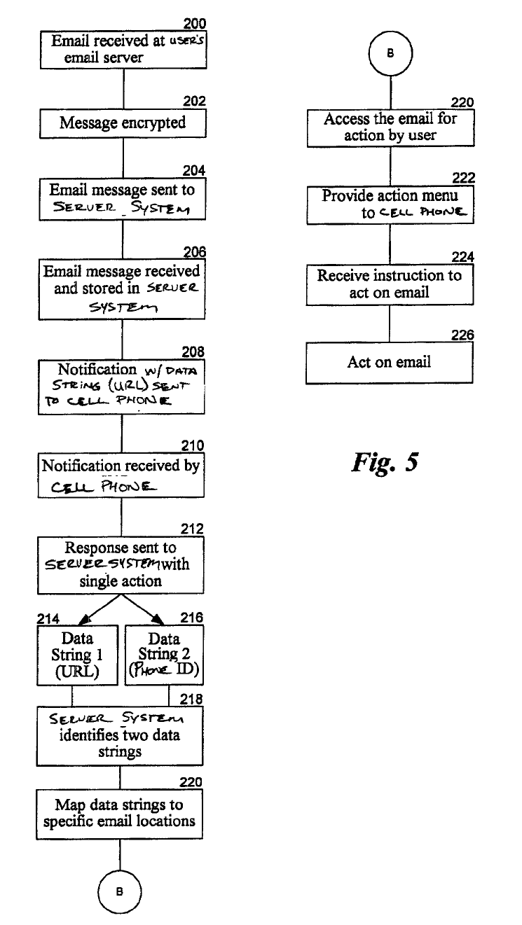

FIG. 5 is a schematic block diagram representing a communication flow in a WAP email delivery embodiment. This block diagram has similarities to the block diagram of FIG. 4, and the primary differences will be highlighted in the following discussion. When a cell phone user has a cell phone having a WAP browser or the like, email delivery to the user's cell phone can be accomplished via a WAP session. The use of a WAP session allows for increased number of options for the cell phone user, particularly because the communication with the cell phone is provided over the phone's data channel, as discussed above.

In the embodiment of FIG. 5, an email is received at the user's email server (block 200). The message may be encrypted if desired or necessary (block 202). Encryption of the email may not be necessary and may be skipped in other embodiments. The email is sent to the server system (block 204) and the electronic data storage portion receives and stores the email message at a unique location. If the email meets selected criteria as determined at the server system, the message notification portion sends the notification to the cell phone (block 208). The notification is in a WAP scheme with a data string that includes a URL embedded therein. The URL is uniquely assigned to the email for which that notification was sent. The WAP scheme also includes other information about the email, such as the emails sender, date, time, and subject. Even a portion of the emails body content can be included. When the notification is sent (block 208), this action initiates a WAP session with the cell phone over the data channel, such that a larger amount of information can be provided in the WAP scheme. As an example, the WAP scheme can have up to 1,462 characters. In other embodiments, the number of character limitations in the WAP scheme may be varied depending upon the cell phone configuration and data channel configuration.

The cell phone receives the notification with the embedded URL (block 210). The notification is configured so that the user can press the “send” key or another key, and the cell phone automatically sends a response to the server system (block 212). The response is sent over the data channel, thereby closing the communication loop with the server system. The response from the cell phone includes two data strings, the first data string (block 214) containing at least the URL for the specific email, and the second data string includes the cell phone identification information known for that user's cell phone, such as the ANI or DNIS.

The communication-receiving portion of the server system receives and identifies the two data strings (block 218). The message-locating portion of the server system maps the two data strings to the specific email location for that email for which the notification was sent (block 220). The server system retrieves or accesses the email for action by the user (block 222) and the message delivery portion of the server system provides an action menu over the data channel to the cell phone (block 224). At this point, the user has been notified that a specific email has been received, and by pressing only one key on the cell phone, the user directly accesses that specific email and obtains a menu of action options for the email.

After the user is provided with the action menu (block 222), the user selects the action item by depressing a selected key corresponding to the menu item and the action instruction is received by the server system regarding acting on the email (block). The server system then acts on the email (block 226) according to the user's instructions. If the action item is to listen to the email, the server system converts the email from text to speech and plays the audio email to the user. If the user elects to fax the email to another recipient, the gateway server builds a word document from the email and sends the word document to a conventional fax server that faxes the document to the desired recipient. Accordingly, the user can easily access selected emails and act on them during the WAP sessions, thereby proving for easy and quick disposition of email messages.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. The teachings of the invention provided herein can be applied to other email server or delivery systems and wireless communication devices, not necessarily the server system and cell phones described above.

The elements and steps of the various embodiments described above can be combined to provide further embodiments. As an example, the data strings forming the notification to the cell phone could include other unique access components other than a server system phone number or a URL unique to the specific email for which the notice was sent. Another example includes when the notice is provided to the cell phone via the WAP session over the phone's data channel, the server system could be configured to immediately convert the email from text to speech and play the email similar to the embodiment discussed with reference to FIG. 4, rather than immediately providing a menu of options for that specific email for which the notice was sent.

These and other changes can be made to the invention in light of the above detailed description. In general, in the following claims, the terms used should not be construed to limit the invention to the specific embodiments disclosed in the specification and the claims, but should be construed to include all systems and methods that operate under the claims to provide email to a wireless communication device. Accordingly, the invention is not limited by the disclosure, but instead the scope of the invention is to be determined entirely by the claims.

We claim:

1. An electronic communication message delivery system, comprising::
an electronic data storage portion configured to receive and store electronic communication messages, each electronic communication message being stored in a unique location;
a message notification portion that provides a notification to a selected wireless communication device that the electronic data storage portion has received a selected electronic communication message, the notification containing a first data string unique to the selected electronic communication message for which the notice was provide and being in a format that allows the wireless communication device to initiate a response to the electronic data storage portion upon activation of only one input member on the wireless communication device;
a communication receiving portion that receives the response from the wireless communication device, the response including a second data string and the first data string, the second data string including selected identification information unique to the wireless communication device, the receiving portion configured to recognize the first and second data strings;
a message locating portion that determines the unique location of the selected. electronic communication message on the electronic data storage portion based upon the combination of the first and second data strings;
a message delivery portion configured to deliver the selected electronic communication message to the wireless communication device without requiring activation of a second input device on the wireless communication device.

2. The electronic communication message delivery system of claim 1, further including an encryption portion coupled to the electronic storage device and configured to encrypt the selected electronic communication message.

3. The electronic communication message delivery system of claim 1 wherein the electronic data storage portion, the message notification portion, the communication receiving portion, the message locating portion, and the message delivery portion are on one or more electronic communication servers.

4. The electronic communication message delivery system of claim 1 wherein the message notification portion provides the first data string in the form of a telephone number that can be called by the wireless communication device upon activation of the one input member on the wireless communication device.

5. The electronic communication message delivery system of claim 1 wherein the message notification portion provides the first data string to the wireless communication device in a small message sending (SMS) protocol recognizable by the wireless communication device.

6. The electronic communication message delivery system of claim 1 wherein the message notification portion provides the first data string to the wireless communication device on a small message sending (SMS) channel of the wireless communication device.

7. The electronic communication message delivery system of claim 1 wherein the message notification portion provides the first data string to the wireless communication device in a wireless access protocol format recognizable by the wireless, communication device.

8. The electronic communication message delivery system of claim 1 wherein the message notification portion provides the first data string to the wireless communication device on a data channel of the wireless communication device and in a wireless access protocol.

9. The electronic communication message system of claim 1 wherein the message notification portion provides the notification to a wireless telephone, the message notification portion provides the first data string that includes a phone number recognizable by the wireless telephone in a form that allows the wireless telephone to initiate a call based upon the telephone number upon activation of only one key on the wireless telephone.

10. The electronic communication message delivery system of claim 1 further comprising a message conversion portion coupled to the message locating portion and configured to convert the selected electronic communication message into an audio message, and the message delivery portion being configured to deliver the audio message to the wireless communication device.

11. The electronic communication message delivery system of claim 10 wherein the message conversion portion is a text-to-speech conversion program.

12. A one-touch system for providing audio email to a recipient with a wireless phone, comprising:
an email storage portion configured to receive and store a plurality of email messages, each email message being stored in a unique location;
a message notification portion that provides a notification to a selected wireless phone indicating that the email storage portion has received a selected email for delivery to the wireless phone, the notification including a first data set being unique to the selected email, the first data set being in a protocol recognized by the wireless phone to allow the wireless phone to connect and send a response to the email storage device upon activating only one key on the wireless phone, the response including the first data set and a second data set that includes identification information unique to the wireless phone;
a communication receiving portion that receives the response from the wireless phone, the communication receiving portion being configured to recognize the first and second data sets;
an email retrieving portion coupled to the email storage portion, the email storage portion being configured to determine the unique location of the email based upon the combination of the first and second data sets and to retrieve the email from that unique location; and
an email delivery portion configured to deliver the email message retrieved from the email storage portion to the wireless phone.

13. The one-touch system of claim 12 further comprising a speech-to-text conversion program configured to convert the email message from a text message to an audio email message, and the email delivery portion is configured deliver the audio email message to the wireless phone.

14. The one-touch system of claim 12 wherein the email delivery portion is configured deliver the audio email message to the wireless phone automatically without a second key on the wireless phone being activated.

15. The one-touch system of claim 12 wherein the email storage portion, the message notification portion, the communication receiving portion, the email retrieving portion, and the email delivery portion are included on one or more servers.

16. The one-touch system of claim 12, further comprising an email response portion that receives an audio email response from the wireless phone; and
an audio email delivery portion that delivers the audio email response to a selected email address.

17. The one-touch system of claim 12 wherein the message notification portion provides the first data set in the form of a telephone number that can be automatically called by the wireless phone upon activation of the one key on the wireless phone.

18. The one-touch system of claim 12 wherein the message notification portion provides the first data set to the wireless phone along an small message sending (SMS) channel.

19. The one-touch system of claim 12 wherein the message notification portion provides the first data set to the wireless phone along a data channel and in a wireless access protocol format.

20. The one-touch system of claim 12 wherein the communication receiving portion receives the second data string in the form of a wireless phone identification number unique to that wireless phone.

21. The one-touch system of claim 12, further comprises an encryption mechanism coupled to the email storage portion and configured to encrypt the email.

22. A method of providing an electronic communication message to a wireless communication device, comprising:
receiving an electronic communication message in a server system;
storing the electronic communication message on an electronic communication server in the server system, the electronic communication message being stored at a unique location on the server;
sending a message notification to the wireless communication device indicating receipt of the electronic communication message, the message notification containing a first data string in a protocol recognized by the wireless communication device, the first data string being unique to the selected electronic communication message and being configured to allow the wireless communication device to automatically connect to the server system by activating only one input member on the wireless communication device;
receiving a call from the wireless communication device in response to the notification to provide a communication loop with between the wireless communication device and the server system;
identifying over the communication loop the first data string and a second data string from the wireless communication device, the second data string including identification information unique to the wireless communication device;
determining the unique location address of the electronic communication message on the server based upon the first and second data strings;
retrieving the electronic communication message from the server; and
transmitting the electronic communication message to the wireless communication device.

23. The method of claim 22 further including converting the electronic communication message from a text message to an audio message, and transmitting the electronic communication message included transmitting the audio message directly to the wireless communication device over the communication loop.

24. The method of claim 23 wherein the audio message is transmitted automatically to the wireless communication device over the communication loop without requiring activation of a second input member.

25. The method of claim 22 wherein sending the message notification includes sending the message notification to the wireless communication device in a short message service protocol.

26. The method of claim 22, wherein sending the message notification includes providing the first data string in the message notification and the first data string includes a phone number.

27. The method of claim 22 wherein sending the message notification includes sending the message notification to the wireless communication device in a wireless access protocol.

28. The method of claim 22 wherein sending the message notification includes sending the first data string that includes an URL address.

29. The method of claim 22 further comprising receiving instructions from the wireless communication device for acting on to the electronic communication message.

30. The method of claim 22 wherein sending the message notification includes sending the message notification to a wireless telephone.

31. A method of receiving a electronic communication message on a wireless communication device, comprising:
receiving on the wireless communication device a specific notification from server indicating that a selected electronic communication message has been received by the server, the server having an electronic communication message stored in a unique location thereon, the notification containing a first data string that is specifically assigned to the electronic communication message, the first data string being usable by the wireless communication device to contact the server;
contacting the server via the wireless communication device by activating only a single input device so the wireless device uses the first data string to contact the server and forms a communication loop between the wireless device and the server;
providing over the communication loop the first data string and a second data string from the wireless communication device to the server, the second data string including identification information unique to the wireless communication device, the first and second data strings being provided so the server identifies the unique location of the electronic communication message and retrieves the electronic communication message based upon the combination of the first and second data strings;
receiving direct access to the electronic communication message for which the specific notification was received, the direct access being from the wireless communication device and the direct access being received after the electronic communication message is retrieved on the server based upon the first and second data strings, and the access being received without having to activating another input device on the wireless communication device.

32. The method of claim 31 wherein receiving access to the electronic communication message includes receiving the electronic communication message at the wireless communication device in an audio format.

33. The method of claim 31 further comprising acting on the electronic communication message for which access is received by the wireless communication device.

34. The method of claim 31 wherein the wireless communication device includes a short message sending channel, and receiving the notification includes receiving the notification on the short message sending channel.

35. The method of claim 31 wherein the wireless communication device includes a data channel, and receiving the notification includes receiving the notification in a wireless access protocol on the data channel.

36. The method of claim 31 where receiving notification includes receiving the notification on a wireless phone, contacting the server includes contacting the server via the wireless phone, and providing the first and second data strings includes providing the first and second data strings from the wireless telephone.

37. The method of claim 31 further comprising:
receiving on the wireless communication device a second notification from server indicating that a second electronic communication message has been received by the server, the server having the second electronic communication message stored in a second unique location different from the first unique location, the notification containing a third data string specifically assigned to the second electronic communication message, the third data string being usable by the wireless communication device to contact the server;
contacting the server via the wireless communication device by activating only the single input device so the wireless device uses the third data string to contact the server and forms a second communication loop between the wireless device and the server;
providing over the communication loop the third data string and a fourth data string from the wireless communication device to the server, the fourth data string including identification information unique to the wireless communication device, the third and fourth data strings being provided so the server identifies the unique location of the second electronic communication message and retrieves the second electronic communication message based upon the combination of the third and fourth data strings;
receiving direct access to the second electronic communication message for which the second notification was received, the direct access being after the electronic communication message is retrieved on the server based upon the third and fourth data strings, and the access being received without having to activating another input device on the wireless communication device.
